(19) United States
(12) Patent Application Publication
(10) Pub. No.: US 2016/0188106 A1
(43) Pub. Date: Jun. 30, 2016

(54) TOUCH-SENSITIVE PANEL AND METHOD OF DETECTING TOUCH LOCATION THEREON

(71) Applicant: Shenzhen China Star Optoelectronics Technology Co. Ltd., Shenzhen, Guangdong (CN)

(72) Inventors: Jie QIU, Shenzhen, Guangdong (CN); Yung-lun LIN, Shenzhen, Guangdong (CN); Ruhai FU, Shenzhen, Guangdong (CN); Chengliang YE, Shenzhen, Guangdong (CN); Chun-kai CHANG, Shenzhen, Guangdong (CN)

(73) Assignee: Shenzhen China Star Optoelectronics Technology Co. Ltd., Shenzhen, Guangdong (CN)

(21) Appl. No.: 14/433,652

(22) PCT Filed: Jan. 9, 2015
(86) PCT No.: PCT/CN2015/070413

§ 371 Date: Apr. 4, 2015

(30) Foreign Application Priority Data
Dec. 29, 2014 (CN) 2014108431388

(51) Int. Cl. G06F 3/041; G06F 3/0488; G06F 3/044

(52) U.S. Cl. CPC G06F 3/0418; G06F 3/0412; G06F 3/044; G06F 3/0488; G06F 2203/04808; G06F 2203/04104

(57) ABSTRACT

The present invention provides a touch-sensitive panel which contains a substrate, a plurality of first and second electrodes on the substrate, and a detection module connecting with the first and second electrode. The first and second electrodes are arranged alternately both along a lateral direction and a longitudinal direction of an effective touch area of the touch-sensitive panel so that an actual touch area by an object contains a first area involving a first electrode and a second area involving a second electrode where the first and second areas are not identical. The touch-sensitive panel is capable of avoiding ghost positions, and making the electrodes structurally simpler.

### BACKGROUND OF THE INVENTION

1. Field of the Invention

The present invention generally relates to touch control and display technology, and particularly relates to a touch-sensitive panel and a method of detecting touch location on the touch-sensitive panel.

2. The Related Arts

Currently the two more common touch-sensitive screens are the so-called self-capacitance and mutual-capacitance screens. The self-capacitance screens are more sensitive and accurate, but they suffer problems such as ghost position, and therefore mutual-capacitance technique is mainly adopted in touch-sensitive screens. But mutual-sensitive screens have their own issues such as complex structure and more susceptible to interference.

Therefore an improved touch-sensitive panel and a method of detecting touch location on the touch-sensitive panel are required.

### SUMMARY OF THE INVENTION

The technical issue to be addressed by the present invention is to provide a touch-sensitive panel and a method of detecting a touch location on the touch-sensitive panel so as to avoid ghost positions and to make the electrodes structurally simpler.

To address the technical issue, the present invention provides a touch-sensitive panel which contains a substrate, a plurality of first and second electrodes on the substrate, and a detection module connecting with the first and second electrode. The first and second electrodes are arranged alternately both along a lateral direction and a longitudinal direction of an effective touch area of the touch-sensitive panel so that an actual touch area by an object contains a first area involving a first electrode and a second area involving a second electrode where the first and second areas are not identical. The detection module determines a lateral coordinate of the actual touch area by detecting a capacitance variation between the first and second electrodes of the actual touch area. The detection module determines a longitudinal coordinate of the actual touch area by detecting a difference of the capacitance variations between the first electrode of the actual touch area and the object, and between the second electrode of the actual touch area and the object. The shape of each first electrode complements the shape of each second electrode. A pair of a first electrode and a complementing and neighboring second electrode constitutes a touch control node. The actual touch area is on a touch control node.

Preferably, each first electrode is shaped as a right triangle, each second electrode is shaped as a right trapezoid, a pair of a first electrode and a complementing and neighboring second electrode constitutes a rectangle-shaped touch control node, and a plurality of the rectangle-shaped touch control nodes are arranged in an array within the effective touch area.

Preferably, each first electrode is shaped as a right triangle, each second electrode is shaped as a right triangle, a pair of a first electrode and a complementing and neighboring second electrode constitutes a rectangle-shaped touch control node, and a plurality of the rectangle-shaped touch control nodes are arranged in an array within the effective touch area.

Alternatively, the touch-sensitive panel contains a substrate, a plurality of first and second electrodes on the substrate, and a detection module connecting with the first and second electrodes. The first and second electrodes are arranged alternately both along a lateral direction and a longitudinal direction of an effective touch area of the touch-sensitive panel so that an actual touch area by an object contains a first area involving a first electrode and a second area involving a second electrode where the first and second areas are not identical. The detection module determines a lateral coordinate of the actual touch area by detecting a capacitance between the first and second electrodes of the actual touch area. The detection module determines a longitudinal coordinate of the actual touch area by detecting a capacitance between the first electrode of the actual touch area and the object, and another capacitance between the second electrode of the actual touch area and the object.

Preferably, the shape of each first electrode complements the shape of each second electrode, a pair of a first electrode and a complementing and neighboring second electrode constitutes a touch control node, and the actual touch area is on a touch control node.

Preferably, each first electrode is shaped as a right triangle, each second electrode is shaped as a right trapezoid, a pair of a first electrode and a complementing and neighboring second electrode constitutes a rectangle-shaped touch control node, and a plurality of the rectangle-shaped touch control nodes are arranged in an array within the effective touch area.

Preferably, each first electrode is shaped as a right triangle, each second electrode is shaped as a right triangle, a pair of a first electrode and a complementing and neighboring second electrode constitutes a rectangle-shaped touch control node, and a plurality of the rectangle-shaped touch control nodes are arranged in an array within the effective touch area.

Preferably, the substrate is a CF substrate. The touch-sensitive panel further contains a plurality of pixel units arranged in an array on the substrate, a black matrix among neighboring pixel units, and a touch control layer corresponding to the black matrix. The first and second electrodes are configured in the touch control layer.

The touch control layer can be configured on the substrate, and the black matrix is configured on the touch control layer.

Alternatively, the black matrix is configured on the substrate, and the touch control layer is configured on the black matrix.

Alternatively, the substrate can be a TFT substrate.

To address the technical issue, the present invention provides a method of detecting a touch location on a touch-sensitive panel. The touch-sensitive panel contains a substrate, a plurality of first and second electrodes on the substrate, and a detection module connecting with the first and second electrodes. The first and second electrodes are arranged alternately both along a lateral direction and a longitudinal direction of an effective touch area of the touch-sensitive panel so that an actual touch area by an object contains a first area involving a first electrode and a second area involving a second electrode where the first and second areas are not identical. The method contains the steps of: detecting a capacitance between a first electrode and a second electrode within an actual touch area by an object, and determining a lateral coordinate of the actual touch area accordingly; and detecting the capacitances between the first electrode and the object and between the second electrode and the object, respectively, and determining a longitudinal coordinate of the actual touch area accordingly.

The step of determining the lateral coordinate of the actual touch area contains: detecting a capacitance variation between the first and second electrodes so as to determine the lateral coordinate of the actual touch area accordingly; and the step of determining the longitudinal coordinate contains: detecting capacitance variations between the first electrode and the object and between the second electrode and the object, respectively, and obtaining a difference between the capacitance variations so as to determine the longitudinal coordinate.

The benefit of the present invention is as follows. By alternately arranging the first and second electrodes laterally and longitudinally in a touch-sensitive panel's effective touch area, an actual touch area by an object includes a first area involving a first electrode and a second area involving a neighboring second electrode. The first and second areas are not identical. A lateral coordinate of the actual touch area is determined in accordance with a detected capacitance between the first and second electrodes. A longitudinal coordinate of the actual touch area is determined in accordance with detected capacitances between the first electrode and the object and between the second electrode and the object. The present invention is capable of avoiding ghost positions, and simplifying the electrodes' structure through such design.

The advantage of the present invention is that, by achieving a high-degree of vacuum in the vacuum chamber, products produced from the touch-sensitive panels do not suffer reduced product life due to compromised vacuum environment.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic diagram showing a touch-sensitive panel according to an embodiment of the present invention;

FIG. 1a is a schematic diagram showing an arrangement of a first electrode and a second electrode according to an embodiment of the present invention.

FIG. 2 is a sectional diagram showing a touch-sensitive panel according to an embodiment of the present invention;

FIG. 2a is a sectional diagram showing a touch-sensitive panel according to another embodiment of the present invention; and

FIG. 3 is a flow diagram showing a method of detecting a touch location on a touch-sensitive panel according to an embodiment of the present invention.

### DETAILED DESCRIPTION OF THE PREFERRED EMBODIMENTS

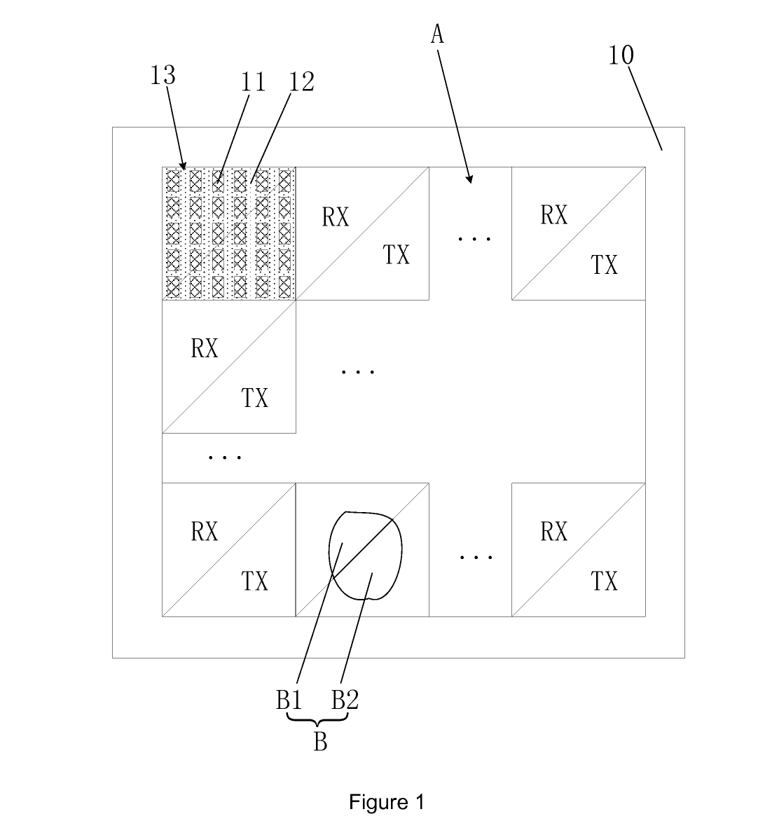

FIG. 1 is a schematic diagram showing a touch-sensitive panel according to an embodiment of the present invention. As illustrated, the touch-sensitive panel contains a substrate 10, a number of first electrodes RX, and a number of second electrodes TX, both configured on the substrate 10.

In an effective touch area A of the touch-sensitive panel, the first and second electrodes RX and TX are arranged alternately both along a lateral direction and a longitudinal direction. Therefore, when an object touches the effective touch area A, an actual touch area B includes a first area B1 involving a first electrode RX and a second area B2 involving a second electrode TX, and the first and second areas B1 and B2 are not identical. The touch-sensitive panel further contains a detection module (not shown) connected with the first and second electrodes RX and TX. The detection module determines a lateral coordinate of the actual touch area B by detecting a capacitance variation between the first electrode RX and the neighboring second electrode TX. A longitudinal coordinate is determined by detecting a difference of the capacitance variations between the first electrode RX and the finger, and between the second electrode TX and the finger.

More specifically, if the object is finger, a coupling capacitance between the first and second electrodes RX and TX would vary when the finger touches the actual touch area B. By detecting the variation of the coupling capacitance between the first and second electrodes RX and TX, the detection module can determine the lateral coordinate of the actual touch area B. On the other hand, as the first and second areas B1 and B2 are not identical, capacitance variation between the first electrode RX and the finger is different from that between the second electrode TX and the finger. The detection module determines the longitudinal coordinate of the actual touch area B by detecting the difference of the two capacitance variations. In alternative embodiments, the detection module can use a ratio between the two capacitance variations so as to determine the longitudinal coordinate.

Preferably, the shape of each first electrode RX complements the shape of each second electrode TX. A pair of a first electrode RX and a complementing and neighboring second electrode TX constitutes a touch control node 13, and an actual touch area is located on a touch node 13.

Preferable, the shapes of each first and second electrode RX and TX are right triangles, and a pair of a first electrode RX and a complementing and neighboring second electrode TX constitutes a rectangle-shaped touch control node 13. A number of such rectangle-shaped touch control nodes 13 are arranged in an array within the effective touch area A. More preferably, the shapes of each first and second electrode RX and TX are isosceles right triangles, and a pair of a first electrode RX and a complementing and neighboring second electrode TX constitutes a square-shaped touch control node 13. In an alternative embodiment shown in FIG. 1a, the first electrode RX is shaped as a right triangle whereas the second electrode TX is shaped as a right trapezoid. The two electrodes RX and TX then constitute a rectangle-shaped touch control node 13. A number of such rectangle-shaped touch control nodes 13 are then arranged in an array within the effective touch area A.

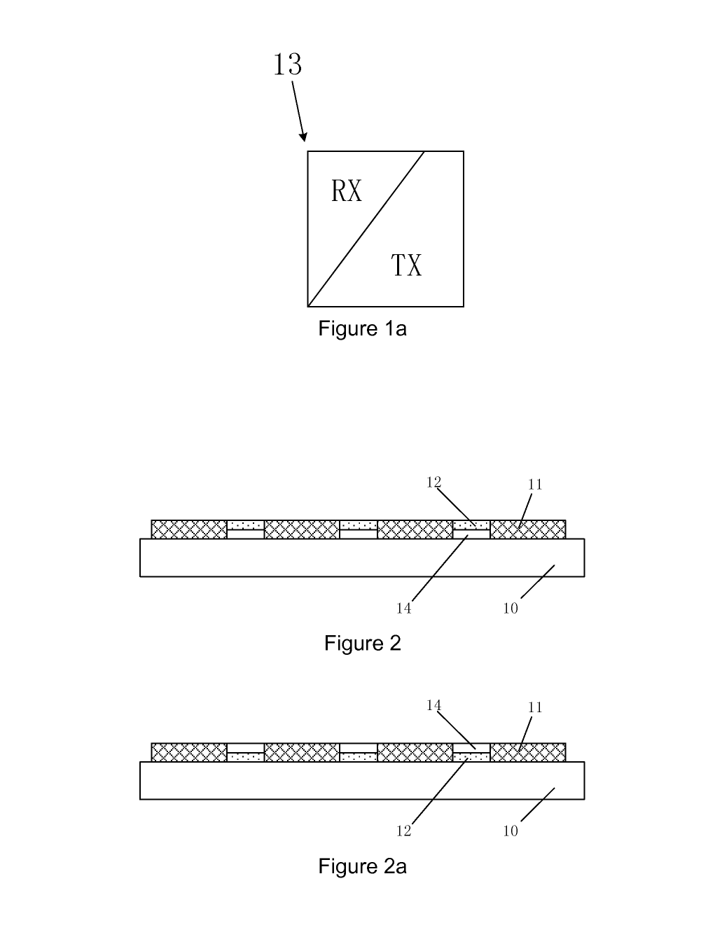

FIG. 2 is a sectional diagram showing a touch-sensitive panel according to an embodiment of the present invention. As illustrated, the substrate 10 is a CF substrate. The touch-sensitive panel further contains pixel units 11 arranged in an array on the substrate 10, and a black matrix 12 among neighboring pixel units 11. The first and second electrodes RX and TX are configured in a touch control layer 14 corresponding to the black matrix 12 (not shown in FIG. 1). Preferably, the touch control layer 14 is configured on the substrate 10, and the black matrix 12 is configured on the touch control layer 14. FIG. 2a is a sectional diagram showing a touch-sensitive panel according to another embodiment of the present invention where the black matrix 12 is configured on the substrate 10, and the touch control layer 14 is in turn configured on the black matrix 12. At where the first electrodes RX are required, the control layer 14 corresponding to the black matrix 12 forms the first electrodes RX. Similarly, at where the second electrodes TX are required, the control layer 14 corresponding to the black matrix 12 forms the second electrodes TX

In alternative embodiments, the substrate 10 can be a TFT array substrate. When a CF substrate is paired with a TFT array substrate 10, the touch control layer 14 is configured on the TFT array substrate 10 and located correspondingly to the black matrix 12 on the CF substrate.

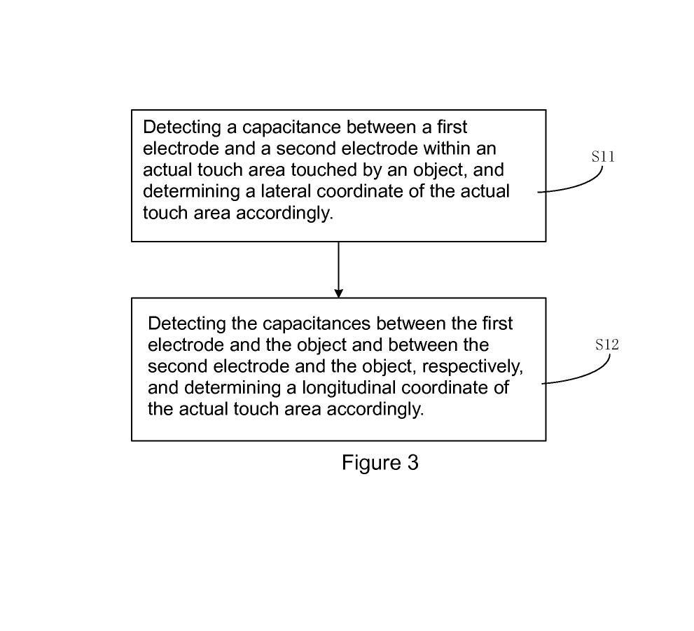

FIG. 3 is a flow diagram showing a method of detecting touch location on a touch-sensitive panel according to an embodiment of the present invention. The method is implemented using a touch-sensitive panel described above and contains the following steps.

In step S11, a coupling capacitance between a first electrode RX and a second electrode TX within an actual touch area by an object is detected, and a lateral coordinate of the actual touch area is determined accordingly.

More specifically, if the object is finger, a coupling capacitance between the first and second electrodes RX and TX would vary when the finger touches the actual touch area B. By detecting the variation of the coupling capacitance between the first and second electrodes RX and TX, the lateral coordinate of the actual touch area B is determined.

In step S12, the capacitances between the first electrode RX and the object and between the second electrode TX and the object are detected, respectively, and a longitudinal coordinate of the actual touch area is determined accordingly.

More specifically, as the first and second areas B1 and B2 of the actual touch area B are not identical, capacitance variation between the first electrode RX and the finger is different from that between the second electrode TX and the finger. The longitudinal coordinate of the actual touch area B is determined by detecting the difference of the two capacitance variations. In alternative embodiments, the longitudinal coordinate can be determined by using a ratio between the two capacitance variations.

Understandably, the lateral and longitudinal coordinates can be determined simultaneously, or the determination of the longitudinal coordinate is conducted before that of the lateral coordinate in alternative embodiments. In other words, the steps S11 and S12 can be conducted currently, or the step S12 is conducted before S11.

By alternately arranging the first and second electrodes laterally and longitudinally in a touch-sensitive panel's effective touch area, an actual touch area by an object includes a first area involving a first electrode and a second area involving a neighboring second electrode. The first and second areas are not identical. A lateral coordinate of the actual touch area is determined in accordance with a detected capacitance between the first and second electrodes. A longitudinal coordinate of the actual touch area is determined in accordance with detected capacitances between the first electrode and the object and between the second electrode and the object. The present invention is capable of avoiding ghost position, and simplifying the electrodes' structure through such design.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A touch-sensitive panel comprising a substrate, a plurality of first and second electrodes on the substrate, and a detection module connecting with the first and second electrodes, wherein
the first and second electrodes are arranged alternately both along a lateral direction and a longitudinal direction of an effective touch area of the touch-sensitive panel so that an actual touch area by an object comprises a first area involving a first electrode and a second area involving a second electrode where the first and second areas are not identical;
the detection module determines a lateral coordinate of the actual touch area by detecting a capacitance variation between the first and second electrodes of the actual touch area;
the detection module determines a longitudinal coordinate of the actual touch area by detecting a difference of the capacitance variations between the first electrode of the actual touch area and the object, and between the second electrode of the actual touch area and the object;
the shape of each first electrode complements the shape of each second electrode;
a pair of a first electrode and a complementing and neighboring second electrode constitutes a touch control node; and
the actual touch area is on a touch control node.

2. The touch-sensitive panel as claimed in claim 1, wherein each first electrode is shaped as a right triangle; each second electrode is shaped as a right trapezoid; a pair of a first electrode and a complementing and neighboring second electrode constitutes a rectangle-shaped touch control node; and a plurality of the rectangle-shaped touch control nodes are arranged in an array within the effective touch area.

3. The touch-sensitive panel as claimed in claim 1, wherein each first electrode is shaped as a right triangle; each second electrode is shaped as a right triangle; a pair of a first electrode and a complementing and neighboring second electrode constitutes a rectangle-shaped touch control node; and a plurality of the rectangle-shaped touch control nodes are arranged in an array within the effective touch area.

4. A touch-sensitive panel comprising a substrate, a plurality of first and second electrodes on the substrate, and a detection module connecting with the first and second electrodes, wherein
the first and second electrodes are arranged alternately both along a lateral direction and a longitudinal direction of an effective touch area of the touch-sensitive panel so that an actual touch area by an object comprises a first area involving a first electrode and a second area involving a second electrode where the first and second areas are not identical;
the detection module determines a lateral coordinate of the actual touch area by detecting a capacitance between the first and second electrodes of the actual touch area; and
the detection module determines a longitudinal coordinate of the actual touch area by detecting a capacitance between the first electrode of the actual touch area and the object, and another capacitance between the second electrode of the actual touch area and the object.

5. The touch-sensitive panel as claimed in claim 4, wherein the shape of each first electrode complements the shape of each second electrode; a pair of a first electrode and a complementing and neighboring second electrode constitutes a touch control node; and the actual touch area is on a touch control node.

6. The touch-sensitive panel as claimed in claim 5, wherein each first electrode is shaped as a right triangle; each second electrode is shaped as a right trapezoid; a pair of a first electrode and a complementing and neighboring second electrode constitutes a rectangle-shaped touch control node; and a plurality of the rectangle-shaped touch control nodes are arranged in an array within the effective touch area.

7. The touch-sensitive panel as claimed in claim 5, wherein each first electrode is shaped as a right triangle; each second electrode is shaped as a right triangle; a pair of a first electrode and a complementing and neighboring second electrode constitutes a rectangle-shaped touch control node; and a plurality of the rectangle-shaped touch control nodes are arranged in an array within the effective touch area.

8. The touch-sensitive panel as claimed in claim 4, wherein the substrate is a CF substrate; the touch-sensitive panel further comprises a plurality of pixel units arranged in an array on the substrate, a black matrix among neighboring pixel units, and a touch control layer corresponding to the black matrix; and the first and second electrodes are configured in the touch control layer.

9. The touch-sensitive panel as claimed in claim 5, wherein the substrate is a CF substrate; the touch-sensitive panel further comprises a plurality of pixel units arranged in an array on the substrate, a black matrix among neighboring pixel units, and a touch control layer corresponding to the black matrix; and the first and second electrodes are configured in the touch control layer.

10. The touch-sensitive panel as claimed in claim 6, wherein the substrate is a CF substrate; the touch-sensitive panel further comprises a plurality of pixel units arranged in an array on the substrate, a black matrix among neighboring pixel units, and a touch control layer corresponding to the black matrix; and the first and second electrodes are configured in the touch control layer.

11. The touch-sensitive panel as claimed in claim 7, wherein the substrate is a CF substrate; the touch-sensitive panel further comprises a plurality of pixel units arranged in an array on the substrate, a black matrix among neighboring pixel units, and a touch control layer corresponding to the black matrix; and the first and second electrodes are configured in the touch control layer.

12. The touch-sensitive panel as claimed in claim 8, wherein the touch control layer is configured on the substrate; and the black matrix is configured on the touch control layer.

13. The touch-sensitive panel as claimed in claim 8, wherein the black matrix is configured on the substrate; and the touch control layer is configured on the black matrix.

14. The touch-sensitive panel as claimed in claim 4, wherein the substrate is a TFT substrate.

15. The touch-sensitive panel as claimed in claim 5, wherein the substrate is a TFT substrate.

16. The touch-sensitive panel as claimed in claim 6, wherein the substrate is a TFT substrate.

17. The touch-sensitive panel as claimed in claim 7, wherein the substrate is a TFT substrate.

18. A method of detecting a touch location on a touch-sensitive panel, the touch-sensitive panel comprising a substrate, a plurality of first and second electrodes on the substrate, and a detection module connecting with the first and second electrodes, the first and second electrodes arranged alternately both along a lateral direction and a longitudinal direction of an effective touch area of the touch-sensitive panel so that an actual touch area by an object comprises a first area involving a first electrode and a second area involving a second electrode where the first and second areas are not identical, the method comprising the steps of:
detecting a capacitance between a first electrode and a second electrode within an actual touch area by an object, and determining a lateral coordinate of the actual touch area accordingly; and
detecting the capacitances between the first electrode and the object and between the second electrode and the object, respectively, and determining a longitudinal coordinate of the actual touch area accordingly.

19. The method as claimed in claim 18, wherein the step of determining the lateral coordinate of the actual touch area comprises:
detecting a capacitance variation between the first and second electrodes so as to determine the lateral coordinate of the actual touch area accordingly; and
the step of determining the longitudinal coordinate comprises:
detecting capacitance variations between the first electrode and the object and between the second electrode and the object, respectively, and detecting a difference between the capacitance variations so as to determine the longitudinal coordinate.
